(19) United States
(12) Patent Application Publication
(10) Pub. No.: US 2019/0352034 A1
(43) Pub. Date: Nov. 21, 2019

(54) APPLICATOR FOR STAMPED PART AND METHOD FOR APPLYING A STAMPED PART

(71) Applicant: tesa SE, Norderstedt (DE)

(72) Inventor: Marten ROHDE, Luneburg (DE)

(21) Appl. No.: 16/409,512

(22) Filed: May 10, 2019

(30) Foreign Application Priority Data
May 15, 2018 (DE) 10 2018 207 469.0

(51) Int. Cl. B65C 1/04; B65C 9/18; B65C 9/30; B65C 9/42

(52) U.S. Cl. CPC B65C 1/04; B65C 9/42; B65C 9/30; B65C 9/1826

(57) ABSTRACT

An applicator for stamped parts. An example applicator includes a stamped part strip roll made of a stamped part strip, comprising a liner strip and stamped parts arranged separated from each other in a longitudinal direction on the liner strip. The applicator further includes a liner strip take-up reel and a dispensing edge, which is arranged between the stamped part strip roll and the liner strip take-up reel in the running direction, and around which the liner strip can be stripped off. The applicator additionally includes a suction belt, arranged at the dispensing edge, with a pressing surface on an applicator tip, on which the stamped part, detached from the stamped part strip and transferred to the suction belt, can be positioned.

### TECHNICAL FIELD

The invention relates to an applicator for stamped parts with a stamped part strip roll made from a stamped part strip comprising a liner strip and stamped parts arranged separated from each other in a longitudinal direction on the liner strip, with a liner strip take-up reel and with a dispensing edge, about which the liner may be stripped off, arranged between the stamped part strip roll and the liner strip take-up reel in a running direction.

The invention also relates to a method for applying a stamped part on a surface, by unrolling a stamped part strip from a stamped part strip roll and guiding it around a deflection edge.

### BACKGROUND

During the production of motor vehicles, the problem often occurs that openings introduced into body parts must be rebonded after machining processes. For example, body parts may be surface treated with fluid. The fluid required for the surface treatment drains automatically via openings previously introduced into the body parts. The openings are subsequently closed again. Closing the openings is often carried out manually, by detaching stamped parts from a stamped part strip or a stamped part sheet and manually gluing them onto the openings. The stamped parts have a carrier layer and an adhesive layer applied on the one side of the carrier layer. The adhesive layer is generally applied over the entire surface of the carrier layer.

In addition, robotic arms are known in the prior art.

For this purpose, a stamped part roll is available, on which a stamped part strip is wound up in a conventional way. The stamped part strip is generally a liner which is present in a strip shape. The series of stamped parts with a carrier layer and an adhesive layer are applied, spaced apart, on this liner in such a way that the free side of the adhesive layer is glued on the liner, such that the side of the adhesive layer opposite the liner is covered by the carrier layer, so that the adhesive is completely protected. The stamped part strip may then be wound onto a stamped part roll, namely such that the liner is arranged on the coil exterior and the stamped parts are arranged on the coil interior. This is the preferred variant: a winding on a stamped part roll, in which the liner is arranged on the coil interior and the stamped parts are arranged on the coil exterior, is also possible. The free end of the stamped part strip is drawn off in a known way and tensioned into a device, and a robotic arm sucks the stamped part sequentially from the stamped part strip. The robotic arm is designed like a nozzle for this purpose, and sucks on the stamped part at the carrier layer, detaches it from the liner, and presses the stamped part onto the opening in the predefined position.

This method is disadvantageously time consuming, as the robotic arm must be moved back to the stamped part roll after each gluing process in order to detach the next stamped part from the stamped part strip, which is known to the person skilled in the art as pick & place application.

In addition, applicators in the form of label dispensers are known. The label dispenser is thereby arranged on a robotic arm. The label dispenser has the stamped part roll. The stamped part roll is guided to a pressing roller and the liner is automatically stripped and the stamped part is pressed on the hole by moving the label dispenser with the aid of the pressing roller. This method is disadvantageously rather space consuming, as the label dispenser must be drawn across a certain path with the aid of the robotic arm. This is, e.g., disadvantageous in poorly accessible regions of an automotive blank, for example, if the opening to be closed is located directly adjacent to an edge that is bent upward.

In addition, applicators for stamped parts with a dispensing edge are known, at the end of which a roller is arranged which presses the stamped part, detached from the liner, onto a surface. The disadvantage in this applicator for stamped parts is the fact that the roller must roll completely over the stamped part, and therefore an additional region must be present upstream and downstream of the stamped part which approximately corresponds to the radius of the pressing roller.

It is therefore the object of the present invention to provide an applicator for stamped parts which reduces the disadvantages listed above.

It is also the object of the invention to provide a method by means of which stamped parts may be bonded, in which the disadvantage listed above is reduced.

### SUMMARY OF THE INVENTION

With respect to the applicator for stamped parts, the problem is solved by an applicator for stamped parts listed at the outset with the features of claim 1.

The applicator for stamped parts according to the invention comprises a stamped part strip roll made of a stamped part strip, comprising a liner strip and stamped parts arranged separated from each other in a longitudinal direction on the liner strip, a liner strip take-up reel, a dispensing edge which is arranged between the stamped part strip roll and the liner strip take-up reel in a running direction, and around which the liner strip may be stripped off, a suction belt according to the invention with a pressing surface on an applicator tip, onto which the stamped part, detached from the stamped part strip and transferred to the suction belt, is positionable.

The applicator for stamped parts according to the invention uses the idea of detaching the stamped part from the stamped part strip. For this purpose, the stamped part strip is drawn around the dispensing edge, and the stamped part to be detached by this drawing around is transferred to the suction belt and transported by the suction belt to the applicator tip.

The suction belt comprises a perforated endless belt, which is driven by a second drive, and a suction apparatus, which sucks air through the perforations and thus sucks the stamped parts to the outside of the suction belt, is provided in the interior of the closed suction belt. The stamped part is transported by the circulating suction belt from the dispensing edge to the pressing surface. The pressing surface may be designed as flat; however, it may also be curved slightly outward, thus formed as concave. The stamped part is positioned on the pressing surface.

A controller is advantageously provided, which is connected to a first drive for the liner strip take-up reel and is connected to the second drive for the suction belt, and which coordinates the speeds of the liner strip take-up reel and the suction belt. The connections are preferably data carrying connections, and the speed of the liner strip take-up reel and of the suction belt are coordinated so that the speed of the liner strip at the dispensing edge is exactly the same as the speed of the suction belt at the dispensing edge. The suction belt and dispensing edge may preferably slightly overlap in the running direction of the liner strip and of the suction belt.

A sensor, which detects the state that a stamped part is arranged on the pressing surface, is provided at the pressing surface. If a stamped part is arranged at the pressing surface, the sensor emits a signal to the controller, which then switches off the first drive and the second drive. The stamped part then remains on the pressing surface, in that the air flow continuously persists.

A robotic arm is advantageously provided, on which the suction belt is arranged and which is connected to the controller in a data-carrying way, which presses the pressing surface with the stamped part positioned thereon in a perpendicular movement onto a predetermined position on a surface. The robotic arm is preferably connected to the entire applicator for stamped parts, however, it is connected at least to the apparatus on which the suction belt and the pressing surface are arranged, so that the pressing surface, after the stamped part has been positioned thereon, may be pressed on the surface with a movement perpendicular to the surface, and the stamped part is bonded to the surface by the pressing movement.

The stamped parts advantageously comprise a carrier layer and an adhesive layer for this purpose. The stamped part is positioned on the suction belt and also conveyed in this position such that the carrier layer lies directly on the suction belt and the adhesive layer is exposed facing away from the suction belt. The stamped part may then be pressed on the surface by the perpendicular back and forth movement of the pressing surface. The applicator for stamped parts is particularly suited for sealing openings, in particular in auto body parts. As it does not execute a rolling movement, as is necessary in the prior art, only a very small space is required around the hole so that the stamped part may be fixedly bonded to the hole. The stamped part must naturally be somewhat larger than the outer circumference of the hole so that the stamped part may be bonded outside on the circumferential edge of the hole.

The size and the contour of the stamped part are preferably adapted to the pressing surface; the stamped parts and the size and contour of the pressing surface are preferably identically shaped. The stamped parts may be formed as identical pairs; however, it is also conceivable that some stamped parts on the stamped part strip have a first shape and other stamped parts have a second shape, wherein the shapes are preferably arranged sequentially in groups on the stamped part strip.

The object is satisfied in its second aspect by a method with the features of claim 6.

According to the method, a stamped part strip is unrolled from a stamped part strip roll and guided around a dispensing edge, and the stamped part is detached there from the stamped part strip and transferred to a suction belt, which conveys the detached stamped part onto a pressing surface on an applicator tip. The pressing surface with the stamped part is pressed onto the surface. The method according to the invention is particularly suited for carrying out with one of the applicators for stamped parts listed above. Conversely, each of the above-listed applicators for stamped parts is suited for carrying out this method or one of the subsequently mentioned methods.

The suction belt with the suctioned stamped part is advantageously advanced in a clocked way until the stamped part is positioned on the pressing surface and the suction belt is then stopped. The stamped part positioned on the pressing surface is then pressed onto the surface by means of a back and forth movement of a robotic arm. The controller switches the first and second drive back on so that the next stamped part is advanced onto the pressing surface. The liner strip is wound around the liner strip take-up reel by the same extent that the stamped part is advanced on the suction belt.

### BRIEF DESCRIPTION OF THE FIGURES

The invention is described by way of an exemplary embodiment in two figures. As seen in:

FIG. 1 a principle side view of an applicator for stamped parts according to the invention,

FIG. 2 a principle side view of a stamped part strip.

### DETAILED DESCRIPTION

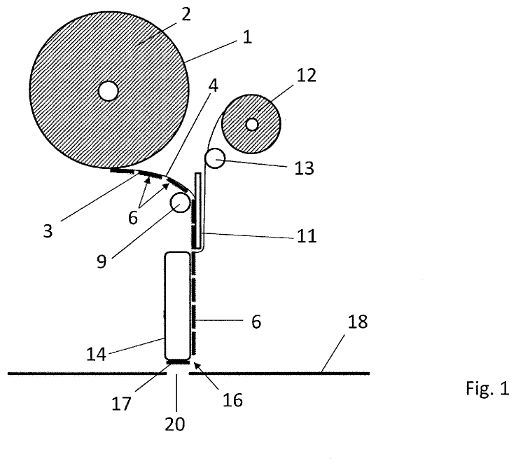

FIG. 1 shows the principle structure of an applicator for stamped parts according to the invention: a housing on which the individual components are arranged, and a robotic arm, on which the applicator for stamped parts is guided, are not indicated.

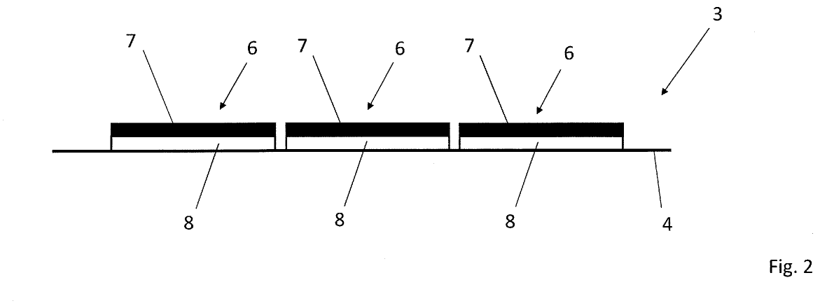

The applicator for stamped parts comprises a receptacle 1 for a stamped part strip roll 2. A stamped part strip 3 is wound on stamped part strip roll 2. The embodiment depicted in FIG. 1 comprises the stamped part strip 3, a liner strip 4, and a layer of stamped parts 6, separated from each other and applied adjacent to each other on the liner strip 4. The arrangement of stamped parts 6 on liner strip 4 is depicted in FIG. 2. Liner strip 4 is composed of a strip that has an essentially endless length and a constant width and a constant thickness. Stamped parts 6 are applied on liner strip 4 adjacent to each other and spaced apart from each other. Stamped parts 6 are shaped identically in pairs in the present case. They respectively comprise a carrier layer 7 and an adhesive layer 8. Stamped parts 6 are applied onto liner strip 4 such that adhesive layer 8 is glued directly to liner strip 4 and adhesive layer 8 is arranged between liner strip 4 and carrier layer 7. Carrier layer 7 functions to provide the exterior shape to stamped part 6.

Carrier layer 7 is composed from the usual plastic materials: mentioned by way of example, but not in a limiting way are polyethylene, polypropylene particularly oriented polypropylene (OPP) generated through monoaxial or biaxial stretching, cyclic olefin copolymers (COC), polyvinyl chloride (PVC), polyester-particularly polyethylene terephthalate (PET) and polyethylene naphthalate (PEN), ethylene vinyl alcohol (EVOH), polyvinylidene chloride (PVDC), polyvinylidene fluoride (PVDF), acrylonitrile (PAN), polycarbonate (PC), polyamid (PA), polyethersulfone (PES) or polyimide (PI).

Adhesive layer 8 is composed from a conventional adhesive. The adhesive comprises a base and a cross-linkable component, also designated as reactive resin.

Various materials, in particular non-polar elastomers, qualify as the base for the adhesive.

Non-polar elastomers, for example, vinyl aromatic-block copolymers, are distinguished in that they may be dissolved in non-polar solvents, i.e., in solvents and/or solvent mixtures whose polarity corresponds to ethyl acetate or which are non-polar. These are, in particular, solvents and/or solvent mixtures with a dielectric constant less than 6.1 [http://en.wikipedia.org/wiki/Solvent] and/or with Hansen solubility parameters of δP Polar≤5.3; δH Hydrogen bonding ≤7.2 [Abbott, Steven and Hansen, Charles M. (2008) Hansen Solubility Parameters in Practice, ISBN 0-9551220-2-3 or Hansen, Charles M. (2007) Hansen solubility parameters: a user's handbook, CRC Press, ISBN 0-8493-7248-8].

If elastomer-block copolymers are used, then these contain at least one type of block with a softening point greater than 40° C., for example, vinyl aromatics (also partially or fully hydrated variants), methyl methacrylate, cyclohexyl methacrylate, isobornyl methacrylate, and isobornyl acrylate.

The block copolymer additionally preferably contains a type of block with a softening point less than 20° C.

Examples for polymer blocks with low softening points (“soft blocks”) are poly ethers, for example, polyethylene glycol, polypropylene glycol or polytetrahydrofuran; polydienes, for example, polybutadiene or polyisoprene, (partially) hydrated polydienes, for example, polyethylene butylene, polyethylene propylene or polybutylene butadiene, polybutylene, polyisobutylene, poly(alkyl vinyl ether); polymer blocks; α,β-unsaturated esters, for example, in particular, acrylate-copolymers.

In one interpretation, the soft block is thereby non-polar and preferably contains butylene or isobutylene or hydrated polydienes as a homopolymer block or copolymer block, the latter being copolymerized preferably with itself or with each other or particularly preferably with other non-polar comonomers. As non-polar comonomers, (partially) hydrated polybutadiene. (partially) hydrated polyisoprene, and/or polyolefins, for example, are suitable.

The cross-linkable component, also designated as reactive resin, is composed from a cyclic ether and is suited for radiochemical and optionally thermal cross-linking at a softening point of less than 40° C., preferably less than 20° C.

Reactive resins based on cyclic ether are particularly epoxies, thus compounds which contain at least one oxirane group, or oxetanes. They may be aromatic or in particular aliphatic or cycloaliphatic in nature.

Usable reactive resins may be monofunctional, difunctional, trifunctional, tetrafunctional or higher functional up to polyfunctional, wherein the functionality relates to the cyclic ether group.

Examples, without claiming to limit them, include 3,4-epoxycyclohexylmethyl-3′,4′-epoxycyclohexane carboxylate (EEC) and derivatives, dicyclopendadiene dioxide and derivatives, 3-ethyl-3-oxetane methanol and derivatives, tetrahydrophthalic acid diglycidyl ester and derivatives, hexahydrophthalic acid diglycidyl ester and derivatives, 1,2-ethane diglycidyl ether and derivatives, 1,3-propane diglycidyl ether and derivatives, 1,4-butanediol diglycidyl ether and derivatives, higher 1,n-alkane diglycidyl ether and derivatives, bis-(3 4-epoxycyclohexylmethyl) adipate and derivatives, vinyl cyclohexyl dioxide and derivatives, 1,4-cyclohexanedimethanol-bis-(3,4-epoxycyclohexane carboxylate) and derivatives, 4,5-epoxytetrahydrophthalic acid diglycidyl ester and derivatives, bis [1-ethyl(3-oxetanyl)methyl]ether and derivatives, pentaerythritol tetraglycidyl ether and derivatives, bisphenol-A-diglycidyl ether (DGEBA), hydrated bisphenol-A-diglycidyl ether, bisphenol-F-diglycidyl ether, hydrated bisphenol-F-diglycidyl ether, epoxy phenol novolacs, hydrated epoxy phenol novolacs, epoxy cresol novolacs, hydrated epoxy cresol novolacs, 2-(7-oxabicyclo)spiro[1,3-dioxane-5,3′-[7]oxabicyclo[4.1.0]-heptane], 1 4-bis((2,3-epoxypropoxy)methyl)cyclohexane.

Reactive resins may be used in the monomeric forms, or also in dimeric, trimeric, etc. up to their oligomeric forms.

Mixtures of reactive resins with each other, however also with other coreactive compounds, like alcohols (monofunctional or multifunctional) or vinyl ethers (monofunctional or multifunctional) are likewise possible.

Adhesive layer 8 is generally applied over the entire surface of carrier layer 7.

According to FIG. 1, the stamped part strip is rolled up on stamped part strip roll 2 in such a way that liner strip 4 is arranged on the coil interior and stamped parts 6 are arranged on the coil exterior. According to the invention, it is also possible to wind it so that liner strip 4 is on the coil exterior.

A free end of wound up stamped part strip 3 is guided around a first deflection roller 9 and from there to a dispensing edge 11. Liner strip 4 is guided around dispensing edge 11 and wound up on a liner strip take-up reel 12. A second deflection roller 13 is arranged between dispensing edge 11 and liner strip take-up reel 12. Liner strip take-up reel 12 is driven by a first drive, not shown. The first drive is connected to a controller, not shown. Liner strip 4 is wound onto liner strip take-up reel 12 by the first drive of liner strip take-up reel 12, and by this means drawn around dispensing edge 11 and unwound from stamped part strip roll 2. During the deflection of stamped part strip 3 around dispensing edge 11 at an angle of approximately 180°, stamped part 6 directly contacting dispensing edge 11 is detached.

A suction belt 14 begins upstream of the outermost leading edge of dispensing edge 11 in the running direction of stamped part strip 3. Suction belt 14 is closed and arranged in a longitudinal loop. Suction belt 14 slightly overlaps dispensing edge 11 at an end facing an applicator tip 16. The overlapping is not indicated in FIG. 1. Stamped part strip 3 is guided between the one end of suction belt 14 and dispensing edge 11, and in the overlapping region, stamped part 6 detaches from liner strip 4 when liner strip 4 is advanced and said stamped part is received by suction belt 14.

Suction belt 14 is composed of a circulating endless strip that has perforations, wherein a suction apparatus is arranged in a loop interior of the endless strip and generates a negative pressure, which sucks air from the outside through the perforations to the inside into the loop and by this means sucks stamped part 6 from the outside to suction belt 14.

Suction belt 14 has a second drive. Suction belt 14 is guided across at least two deflection rollers, of which one deflection roller is driven. However, a plurality of deflection rollers may also be provided. The suction belt has a pressing surface 17 on applicator tip 16. Pressing surface 17 may be designed as flat; however, it may also be curved convexly outward. Suction belt 14 runs past applicator tip 16 during operation and thereby conveys stamped parts 6 across applicator tip 16 and across pressing surface 17. Stamped parts 6 contact suction belt 14 directly with their carrier layer 7, while adhesive layer 1 is arranged on carrier layer 7 facing away from suction belt 14. The second drive of suction belt 14 is likewise connected to the controller in a data-carrying way. A sensor (not shown) is provided on applicator tip 16 and detects the presence of one of stamped parts 6 at applicator tip 16 on pressing surface 17. The sensor is likewise connected to the controller in a data carrying way.

The controller drives the first drive of liner strip take-up reel 12. By this means, stamped part strip 3 is unrolled from stamped part strip roll 2, and initially stamped part 6 is detached by deflecting liner strip 4 about dispensing edge 11 and is guided slightly farther via suction belt 14. The controller is also connected to a suction apparatus, and the controller activates the suction apparatus prior to switching on the first drive. Stamped part 6, detached at dispensing edge 11, is sucked by suction belt 14. The controller activates the second drive of suction belt 14 and thus transports stamped part 6 in the direction of applicator tip 16, while liner strip 4 is simultaneously wound up. Stamped part 6 is continuously detached from liner strip 4 and conveyed farther by suction belt 14 to applicator tip 16. The speed of liner strip 4 at dispensing edge 11 is exactly as great as the speed of suction belt 14 in the direction of applicator tip 16. The speeds are aligned parallel to each other. Stamped parts 6 are detached sequentially detached from stamped part strip 4. Suction belt 14 runs until a first stamped part 6 is positioned on pressing surface 17. The presence of stamped part 6 is detected by means of the sensor and the second drive of suction belt 14 is stopped. The first drive of liner strip take-up reel 12 is stopped simultaneously. During the transport of stamped part 6 or subsequently or previously thereto, pressing surface 17 is moved across a predetermined region of a surface 18 to be bonded and is stopped spaced slightly apart from surface 18. Pressing surface 17, with stamped part 6 positioned on pressing surface 17, is then pressed on to surface 18 in a manner perpendicular to surface 18 and bonded on to surface 18. Afterwards, pressing surface 17 is moved, perpendicularly to surface 18, away from surface 18 and next stamped part 6 is moved onto pressing surface 17, by switching the second drive on again, and simultaneously the first drive, until the sensor detects that next stamped part 6 is positioned on pressing surface 17. Before, during, or after, the applicator for stamped parts is moved by means of the robotic arm and pressing surface 17 is moved across a second predetermined position. The corresponding pressing process is repeated there. The applicator for stamped parts is particularly suited for closing openings 20 in car bodies. The stamped parts 6 are then selected as somewhat larger than openings 20 to be closed, and stamped parts 6 may be bonded to opening 20 to be closed using pressing surface 17, in that stamped part 6 is bonded on the car body at the edge around opening 20 and pressed there.

The preceding description provides various examples of the systems and methods of use disclosed herein which may contain different method steps and alternative combinations of components. It should be understood that; although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps. The systems and methods can also “consist essentially of” or “consist of the various components and steps.” Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited. In the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form. “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. An applicator for stamped parts comprising:
a stamped part strip roll made of a stamped part strip, the stamped part strip comprising a liner strip and stamped parts that are arranged separated from each other in a longitudinal direction on the liner strip,
a liner strip take-up reel,
a dispensing edge disposed proximate the stamped part strip roll and the liner strip take-up reel in the running direction, and around which the liner strip is configured to be stripped off, and
a suction belt disposed proximate the dispensing edge and comprising a pressing surface disposed at an applicator tip, on which the stamped part is configured to be detached from the stamped part strip and transferred to the suction belt where it is positioned for application.

2. The applicator for stamped parts of claim 1, further comprising a controller connected to a first drive for the liner strip take-up reel and also connected to a second drive for the suction belt, wherein the controller coordinates the speeds of the liner strip take-up reel and the suction belt.

3. The applicator for stamped parts of claim 2, further comprising a robotic arm on which the suction belt is arranged and which is connected to the controller; wherein the robotic arm is configured to press the pressing surface with the stamped part positioned thereon onto a surface in a perpendicular movement.

4. The applicator for stamped parts of claim 1, wherein the pressing surface has the size and contour of the stamped parts and the stamped parts are identically shaped.

5. The applicator for stamped parts of claim 1, wherein the dispensing edge slightly overlaps with the suction belt and the stamped part strip is guided between the dispensing edge and the suction belt.

6. A method for applying a stamped part on a surface, the method comprising:
unwinding a stamped part strip from a stamped part strip roll,
guiding the unwound stamped part strip around a deflection edge,
detaching a stamped part from the stamped part strip at the deflection edge,
transferring the stamped part to a suction belt,
conveying the detached stamped part on the suction belt onto a pressing surface on an applicator tip, and
pressing the detached stamped part onto the surface with the pressing surface.

7. The method of claim 6, wherein the suction belt with the suctioned stamped part is advanced in a clocked way until the stamped part is positioned on the pressing surface and then the suction belt is stopped.
